(19) United States
(12) Patent Application Publication
(10) Pub. No.: US 2025/0177087 A1
(43) Pub. Date: Jun. 5, 2025

(54) IMPLANT DRILL AND IMPLANT DRILL SET

(71) Applicant: DENTAURUM GmbH & Co. KG, Ispringen (DE)

(72) Inventors: Mark Stephen Pace, Pforzheim (DE); Andreas Bauer, Bruchsal (DE)

(21) Appl. No.: 18/945,783

(22) Filed: Nov. 13, 2024

(30) Foreign Application Priority Data
Dec. 4, 2023 (DE) 10 2023 133 853.6

(51) Int. Cl. A61C 1/08

(52) U.S. Cl. CPC A61C 1/084

(57) ABSTRACT

The present invention relates to an implant drill for producing bores in the jaw bone for dental implants, comprising a drill blade element with a blade portion and a connecting portion, which are arranged in the axial direction at opposite ends of the drill blade element; and a holding apparatus with a holding portion and an actuating portion, which are arranged in the axial direction at opposite ends of the holding apparatus, and wherein the holding portion has a slot-shaped receptacle that is mirror-symmetrical relative to the rotation axis, with two mutually parallel receptacle surfaces, wherein the connecting portion of the drill blade element is introducible in the axial direction into the receptacle of the holding portion of the holding apparatus, in order to connect the drill blade element non-rotatably to the holding apparatus.

This application claims the benefit of German application No. 10 2023 133 853.6 filed on Dec. 4, 2023, which is incorporated herein by reference in its entirety and for all purposes.

### BACKGROUND OF THE INVENTION

The present invention relates to an implant drill for producing bores in jaw bones for dental implants.

The invention also relates to an implant drill set comprising an implant drill of this type.

Dental implants which serve as carriers for dental prostheses are inserted, typically screwed, into the jaw bone. For this purpose, the jaw bone must be prepared by producing a bore, the size and shape of which correlates as exactly as possible to the implant that is to be inserted. For each dental implant, a plurality of implant drills is usually needed in order to be able to produce different portions of the bore with different diameters sequentially.

The implant drills known from the prior art are normally each configured as a single piece and comprise a drill blade and an actuating portion for connecting to a handheld instrument with which the implant drill is actuated. These implant drills are intended for repeated use, so that for each dental implant, a particular drill (or a set of drills) is needed. The implant drills consist uniformly of a material having the hardness required for the drill blade, typically high-strength high-grade steel or ceramics, wherein the production of the drill is relatively complex due to the different portions with their respective geometries.

### SUMMARY OF THE INVENTION

It is an object of the invention to propose an implant drill and an implant drill set which can be produced and flexibly used with a reduced level of complexity.

This object is achieved according to the invention by means of an implant drill of the type mentioned in the introduction, comprising
a drill blade element which consists of a flat material and is configured substantially mirror-symmetrical relative to a rotation axis of the implant drill, comprising a blade portion with bevelled edges for producing the bore in the jaw bone and a connecting portion, which are arranged in the axial direction at opposite ends of the drill blade element; and
a holding apparatus which is configured substantially rotationally symmetrical relative to the rotation axis, wherein the holding apparatus comprises a holding portion and an actuating portion, which are arranged in the axial direction at opposite ends of the holding apparatus, and wherein the holding portion has a slot-shaped receptacle that is mirror-symmetrical relative to the rotation axis, with two mutually parallel receptacle surfaces,
   wherein the connecting portion of the drill blade element is introducible in the axial direction into the receptacle of the holding portion of the holding apparatus, in order to connect the drill blade element non-rotatably to the holding apparatus.

The invention is therefore based upon the principal concept of producing the drill blade element and the holding apparatus as two separate parts which are connectable to one another in positive-locking manner by means of a simple mechanism. Therefrom comes a first substantial advantage of the invention that just one or a few standardised holding apparatuses can be combined with a large number of different drill blade elements (which are adapted to the respective dental implants) to form an implant drill. The holding apparatus can thus be produced in a correspondingly large number of parts economically.

A second substantial advantage arises from the fact that with the implant drill according to the invention, only the drill blade element must be produced from a high-strength material, whereas a more economical material (e.g. simple high-grade steel) can be used for the holding apparatus. In contrast thereto, single-piece implant drills must consist entirely of a high-strength material, which leads to increased costs.

In a preferred embodiment of the implant drill according to the invention, the holding portion of the holding apparatus has a cylindrical outer surface which serves to be received in a drilling sleeve with a corresponding cylindrical inner surface. The drilling sleeve is situated in a template which is placed on the dentition of the patient, so that with the aid of the drilling sleeve, the position and orientation of the bore can be defined exactly. By means of the substantially rotationally symmetrical form, the holding apparatus can favourably be produced with a material removal process such as, for example, turning, which reduces the production costs. Preferably, the holding apparatus is made from high-grade steel.

The drill blade element of the implant drill according to the invention consists of a flat material the edges of which are bevelled in the region of the blade portion. A drill blade element of this type also has the advantage that it is easily producible with the required size and geometry.

Preferably, the drill blade element is formed integrally from a ceramic material or a metallic material, in particular, from high-strength high-grade steel or surgical steel.

Favourably, the drill blade element is produced by means of eroding, in particular, by means of spark eroding. With this production method, in a single operation, the drill blade element can be cut out of a larger planar material and can simultaneously be provided in the blade portion with bevelled edges as a drill blade. The bevelled edges typically have an angle in the range from 12° to 18° to the thickness direction of the drill blade element, for example, 15°.

The drill blade element preferably has a substantially constant thickness which is preferably in the range from approximately 0.25 to approximately 0.8 mm, more preferably from approximately 0.5 to 0.7 mm. However, the drill blade element can also have a reduced thickness in the region of the tip of the blade portion.

In the holding portion of the implant drill according to the invention, the receptacle surfaces of the slot-shaped receptacle preferably have a spacing that corresponds to the thickness of the drill blade element in order to receive the connecting portion of the drill blade element substantially play-free. In this way, a reliable and precise transfer of the torque from the holding apparatus to the drill blade element is ensured when the bore is produced in the bone.

The actuating portion of the holding apparatus is preferably configured for non-rotatable, releasable connection to a handle. This type of connecting possibility with a handle is known from implant drills from the prior art.

The manner of the connection between the drill blade element and the holding apparatus can be configured differently within the context of the invention. According to a preferred embodiment of the invention, the drill blade element is non-releasably connected to the holding apparatus. In this case, the implant drill according to the invention is intended overall for only a single use, wherein, as a result of the standardised production of the holding apparatus and the subsequent connection to the drill blade element, the cost advantages described above apply in this case also.

The non-releasable connection is preferably realised in that the connecting portion of the blade element is welded or adhesively bonded to the holding portion of the holding apparatus.

In the case of the non-releasable connection, it is advantageous if the slot-shaped receptacle extends over the whole diameter of the holding portion and the connecting portion of the blade element has a width that corresponds substantially to the diameter of the holding portion. By this means, a greatest possible connecting area is available between the two parts and, in the connecting region, a uniform external area without recesses or projections results.

According to a further advantageous embodiment of the invention, the drill blade element is releasably connectable to the holding apparatus. In this case, the holding apparatus, which does not come into direct contact with the body of the patient, can possibly be used multiple times, by which means further cost advantages can be achieved. At least, during the production of a bore, a holding apparatus can be connected and used with two or more drill blade elements sequentially, in order to produce and/or widen the different portions of the bore.

It is particularly favourable if the drill blade element is connectable to the holding apparatus by means of a latching connection or a snap-fit connection.

According to an advantageous embodiment, the connecting portion of the blade element has a central guide portion and two lateral wing portions spaced from the guide portion, wherein the wing portions each have a latching nose oriented toward the rotation axis, wherein the slot-shaped receptacle does not extend over the whole diameter of the holding portion, but rather has a width that corresponds substantially to the width of the central guide portion and wherein the holding portion has two recesses disposed opposite one another on its outer periphery for receiving the latching noses. When the drill blade element is introduced into the holding apparatus, a locking takes place by means of the latching noses so that the drill blade element which is releasably connected to the holding apparatus is secured, in particular, against an axial or radial movement.

Favourably, the locked connection can be released again in a simple manner with the aid of an unlocking tool. For this purpose, it is preferred if the holding portion has a contact surface, adjoining each of the recesses, for an unlocking tool in order to move the lateral wing portions apart and to release the connection between the drill blade element and the holding apparatus.

The holding apparatus preferably has a cleaning bore which connects the end of the slot-shaped receptacle oriented in the direction of the actuating portion to the outer periphery of the holding portion. In the event of the re-use of the holding apparatus, an effective flushing of the slot-shaped receptacle can thereby be ensured when cleaning the holding apparatus.

Also the subject of the present invention is an implant drill set comprising an implant drill according to the invention with a releasable connection between the drill blade element and the holding portion, as well as one or more further drill blade elements, wherein each drill blade element has a connecting portion which is introducible in the axial direction into the receptacle of the holding portion of the holding apparatus, in order to connect the drill blade element non-rotatably to the holding apparatus.

With an implant drill set according to the invention, the provision of a single holding apparatus is sufficient and this must be adapted only with regard to the outer diameter of the holding portion relative to a drilling sleeve that is to be used. The holding apparatus can be combined with a series of different drill blade elements in the set, both for producing a single bore with different portions in the jaw bone as well as for producing a plurality of bores following a suitable cleaning of the holding apparatus. In comparison with a series of implant drills, each consisting integrally of a drill blade element and a holding apparatus, the set according to the invention enables a significant material and cost saving.

Within the implant drill set according to the invention, the connecting portions of all the drill blade elements are preferably configured identically, whereas the blade portions of the drill blade elements can each be configured identically or differently.

The blade portions of the drill blade elements can, in particular, be configured differently in order to produce and/or widen different partial regions of a bore in the jaw bone sequentially.

These and other advantages of the invention will now be described in greater detail based on the following exemplary embodiments, making reference to the drawings.

### BRIEF DESCRIPTION OF THE DRAWINGS

In the individual drawings:

FIG. 1A shows a holding apparatus according to a first exemplary embodiment of an implant drill according to the invention in a side view;

FIG. 1B shows a holding apparatus according to a first exemplary embodiment of an implant drill according to the invention in a perspective view;

FIG. 1C shows a holding apparatus according to a first exemplary embodiment of an implant drill according to the invention in a plan view;

FIG. 2A shows a drill blade element according to the first exemplary embodiment in a side view;

FIG. 2B shows a drill blade element according to the first exemplary embodiment in a perspective view;

FIG. 2C shows a drill blade element according to the first exemplary embodiment in a plan view;

FIG. 3A shows an implant drill according to the first exemplary embodiment in a side view;

FIG. 3B shows an implant drill according to the first exemplary embodiment in a perspective view;

FIG. 3C shows an implant drill according to the first exemplary embodiment in a plan view;

FIG. 3D shows an implant drill according to the first exemplary embodiment in a longitudinal section;

FIG. 4A shows a holding apparatus according to a second exemplary embodiment of an implant drill according to the invention in a side view;

FIG. 4B shows a holding apparatus according to a second exemplary embodiment of an implant drill according to the invention in a perspective view;

FIG. 4C shows a holding apparatus according to a second exemplary embodiment of an implant drill according to the invention in a plan view;

FIG. 5A shows a drill blade element according to the second exemplary embodiment in a side view;

FIG. 5B shows a drill blade element according to the second exemplary embodiment in a perspective view;

FIG. 5C shows a drill blade element according to the second exemplary embodiment in a plan view;

FIG. 6A shows an implant drill according to the second exemplary embodiment in a side view;

FIG. 6B shows an implant drill according to the second exemplary embodiment in a perspective view;

FIG. 6C shows an implant drill according to the second exemplary embodiment in a plan view;

FIG. 6D shows an implant drill according to the second exemplary embodiment in a longitudinal section;

FIG. 7A shows a holding apparatus according to a third exemplary embodiment of an implant drill according to the invention in a side view;

FIG. 7B shows a holding apparatus according to a third exemplary embodiment of an implant drill according to the invention in a perspective view;

FIG. 7C shows a holding apparatus according to a third exemplary embodiment of an implant drill according to the invention in a plan view;

FIG. 8A shows a drill blade element according to the third exemplary embodiment in a side view;

FIG. 8B shows a drill blade element according to the third exemplary embodiment in a perspective view;

FIG. 8C shows a drill blade element according to the third exemplary embodiment in a plan view;

FIG. 9A shows an implant drill according to the third exemplary embodiment in a side view;

FIG. 9B shows an implant drill according to the third exemplary embodiment in a perspective view;

FIG. 9C shows an implant drill according to the third exemplary embodiment in a plan view; and

FIG. 9D shows an implant drill according to the third exemplary embodiment in a longitudinal section.

### DETAILED DESCRIPTION OF THE INVENTION

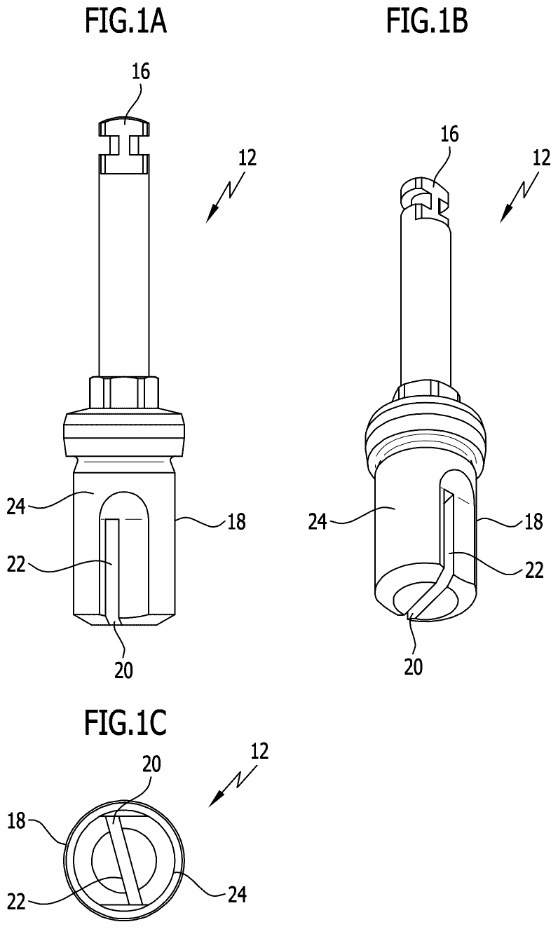

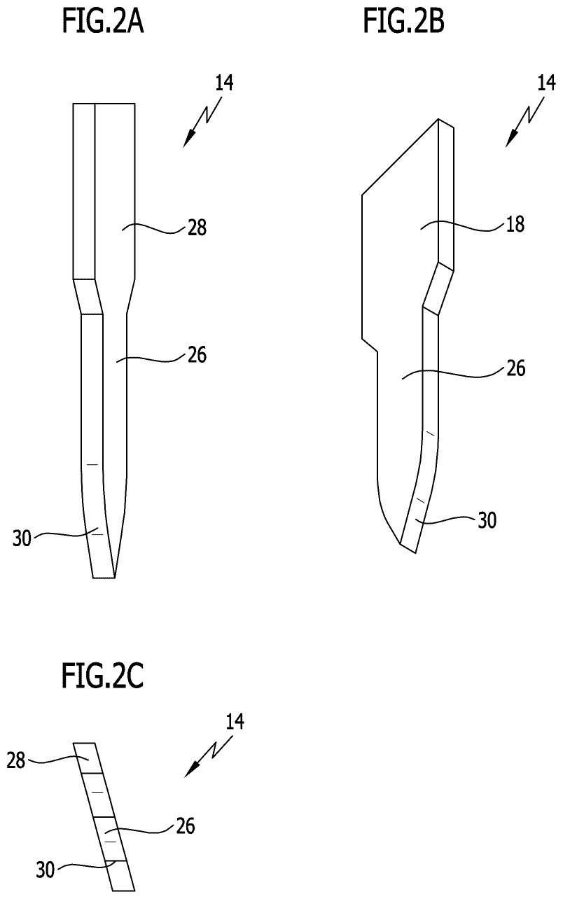

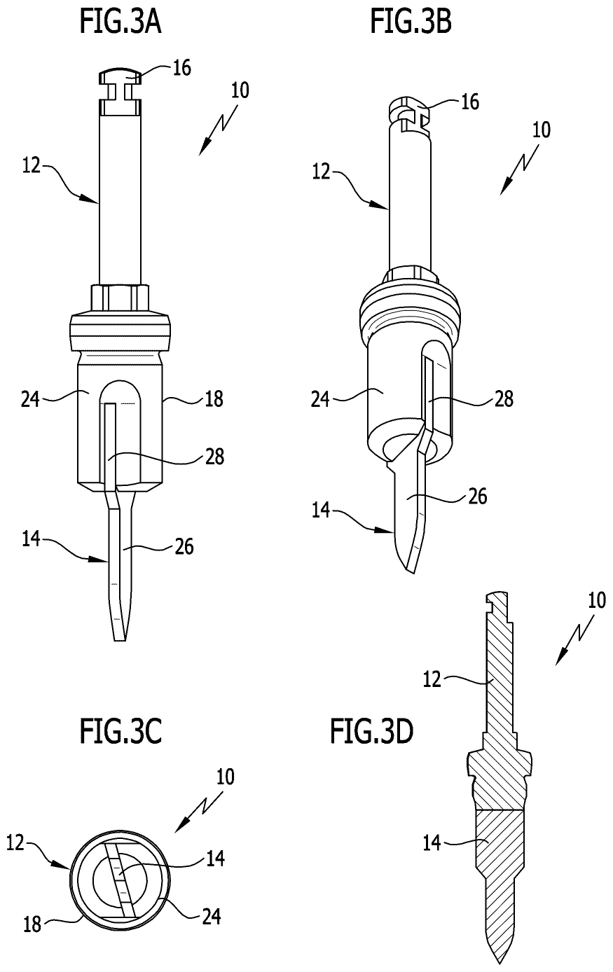

A first exemplary embodiment of an implant drill 10 according to the invention for producing bores in the jaw bone for dental implants is shown in FIGS. 1A to 3D. Herein, FIGS. 1A to 1C show only the holding apparatus 12, FIGS. 2A to 2C show only the drill blade element 14 and FIGS. 3A to 3C show the implant drill 10 comprising the drill blade element 14 and the holding apparatus 12, respectively in a side view, a perspective view and a plan view from below. FIG. 3D shows a longitudinal section through the implant drill 10.

The holding apparatus 12 is configured substantially rotationally symmetrical relative to a rotation axis which extends from top to bottom in the side views and perspective views. At its upper end, the holding apparatus 12 comprises an actuating portion 16, by means of which the implant drill 10 can be connected to a handle (not shown in the drawings). The implant drill 10 is actuated by means of this handle and/or a handheld instrument.

At its lower end, the holding apparatus 12 comprises a holding portion 18 for connecting to the drill blade element 14. The holding portion 18 has a slot-shaped receptacle 20 with two mutually parallel receptacle surfaces 22.

In the region of the holding portion 18, the holding apparatus 12 has a cylindrical outer surface 24. This serves, in particular, for receiving the implant drill 10 in a drilling sleeve (not shown in the drawings) with a corresponding cylindrical inner surface.

The drill blade element 14 is configured substantially mirror-symmetrical relative to the rotation axis of the holding apparatus 12. It comprises, in the lower region, a blade portion 26 to produce the bore in the jaw bone and, in the upper region, a connecting portion 28 for connecting to the holding portion 18 of the holding apparatus 12. The drill blade element 14 is made from a flat material, for example, with a thickness in the region of approximately 0.5 to approximately 0.7 mm and has bevelled edges 30 at least in the blade portion 26 (for example, with an angle of approximately 15° to the thickness direction of the drill blade element 14). The drill blade element 14 according to this first exemplary embodiment of the implant drill according to the invention consists of a high-strength high-grade steel, in particular, surgical steel, and can advantageously be made by means of spark eroding.

For the holding apparatus 12 of the implant drill 10 according to the invention, a high-grade steel with a lower strength as compared with the drill blade element 14 can be used, with the result that a cost saving compared with a single-piece implant drill can be realised.

The connecting portion 28 of the drill blade element 14 is introducible in the axial direction into the slot-shaped receptacle 20 in the holding portion 18 of the holding apparatus 12 and is held in play-free manner between the receptacle surfaces 22, as shown in FIGS. 3A to 3C. In this first exemplary embodiment of the implant drill 10, the drill blade element 14 is provided for non-releasable connection to the holding apparatus 12 and, for this purpose, the holding portion 18 of the drill blade element 14 is welded to the receptacle surfaces 22 of the holding apparatus 12 (preferably by means of laser welding).

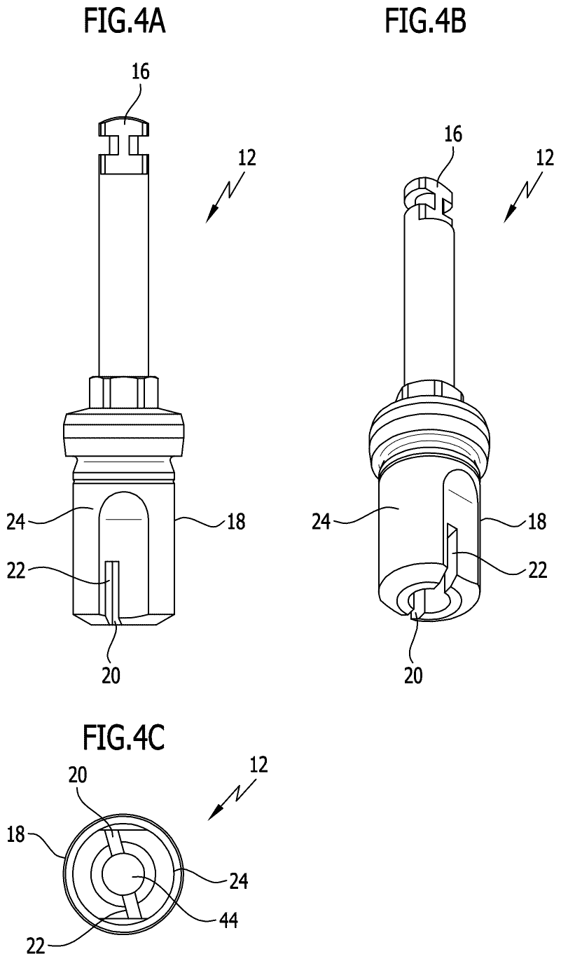

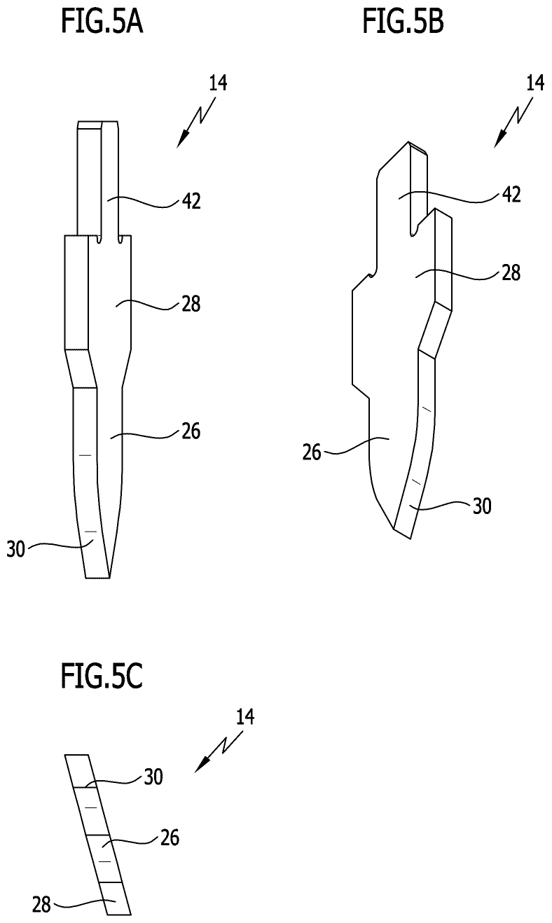

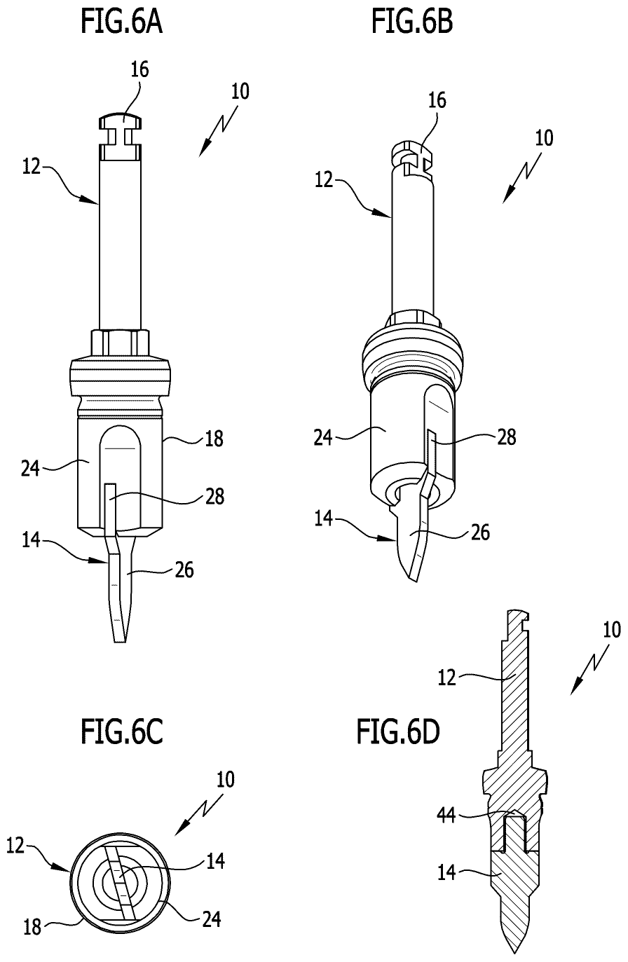

A second exemplary embodiment of an implant drill 40 according to the invention is shown in FIGS. 4A to 6C, wherein FIGS. 4A to 4C show only the holding apparatus 12, FIGS. 5A to 5C show only the drill blade element 14 and FIGS. 6A to 6D show the implant drill 40 comprising the drill blade element 14 and the holding apparatus 12. Identical or corresponding elements are identified, in each case, with the same reference sign as in FIGS. 1A to 3C of the first exemplary embodiment.

The implant drill 40 of the second exemplary embodiment differs from the implant drill 10 of the first exemplary embodiment in that the drill blade element 14 is not made of high-strength high-grade steel, but of a ceramic material. The drill blade element 14 is non-releasably connected to the holding apparatus 12 in this case also, wherein this connection is produced, in particular, by adhesive bonding.

In order to optimize the adhesive bonding, the connecting portion 28 of the ceramic drill blade element 14 has a differing geometry, specifically a portion 42 with a smaller width than the rest of the connecting portion 28. When the drill blade element 14 is connected to the holding portion 12, the portion 42 engages in a corresponding receptacle 44 in the holding portion 18 of the holding apparatus 12, said receptacle extending above the slot-shaped receptacle 20 (see FIG. 6D).

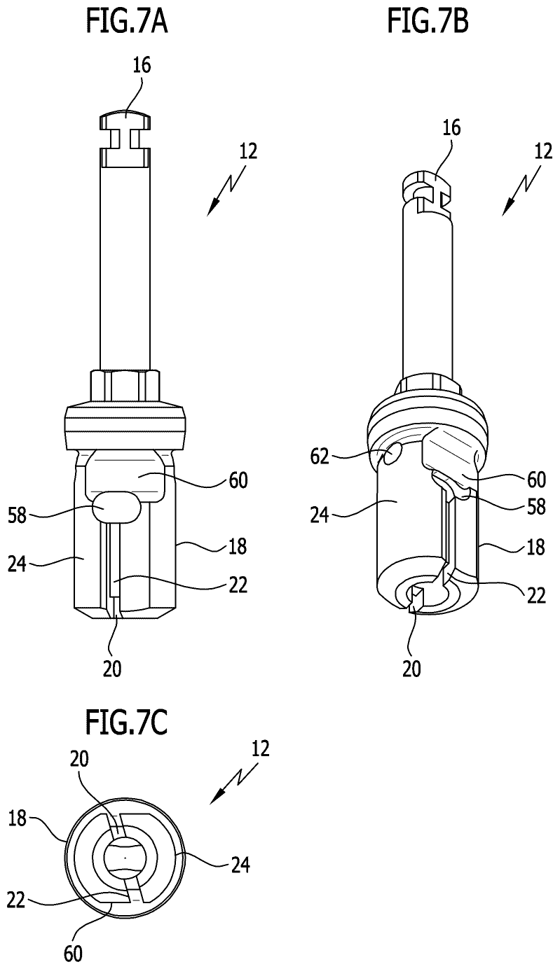

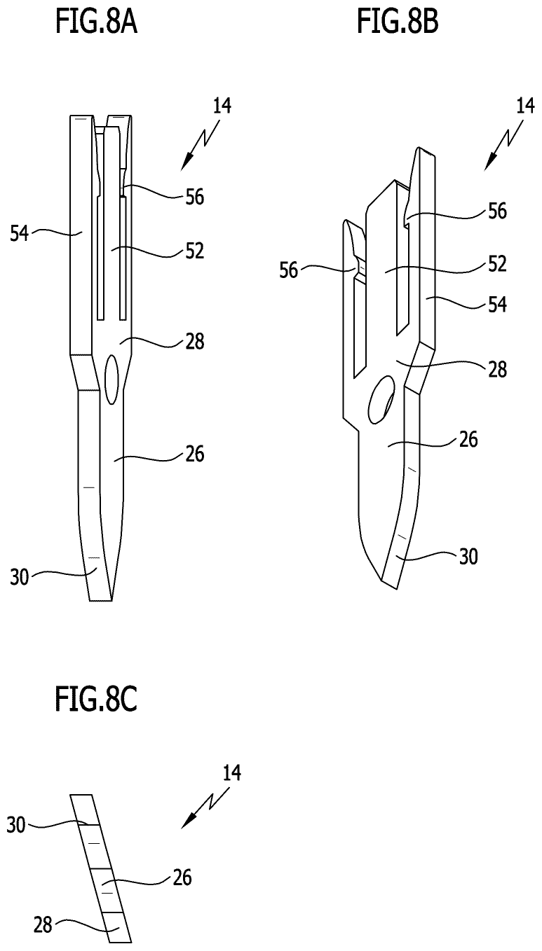

A third exemplary embodiment of an implant drill 50 according to the invention is shown in FIGS. 7A to 9D, wherein FIGS. 7A to 7C show only the holding apparatus 12, FIGS. 8A to 8C show only the drill blade element 14 and

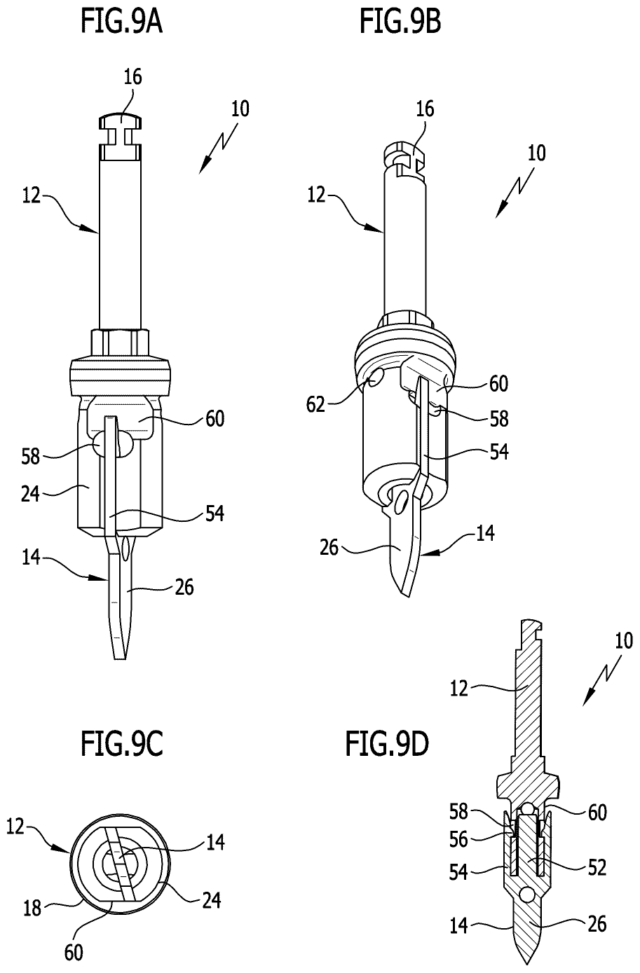

FIGS. 9A to 9D show the implant drill 50 comprising the holding apparatus 12 and the drill blade element 14. Identical or corresponding elements are identified, in each case, with the same reference sign as in FIGS. 1A to 3D of the first exemplary embodiment and FIGS. 4A to 6D of the second exemplary embodiment.

In the third exemplary embodiment of the implant drill 50, a releasable connection between the holding apparatus 12 and the drill blade element 14 is provided, which in this case is realised by means of a mechanical latching connection. As in the case of the first exemplary embodiment, the drill blade element 14 is made of a high-strength high-grade steel, in particular, surgical steel.

In order to form the latching mechanism, the connecting portion 28 of the drill blade element 14 has a central guide portion 52 and two lateral wing portions 54 which are spaced from the guide portion 52. Each wing portion 54 has a latching nose 56 oriented toward the rotation axis.

In the holding portion 18 of the holding apparatus 12 of the implant drill 50, the slot-shaped receptacle 20 does not extend across the whole diameter of the holding portion 18, but rather has a width that substantially corresponds to the width of the central guide portion 42 of the drill blade element 14. On its outer periphery, the holding portion 18 has two opposingly arranged recesses 58 for receiving the latching noses 56. When the connecting portion 28 of the drill blade element 14 is introduced into the slot-shaped receptacle 20 of the holding apparatus 12, in this way, the latching connection is produced. The drill blade element 14 is then connected non-rotatably to the holding apparatus 12 and is secured against an axial or radial movement.

In order to release the connection between the drill blade element 14 and the holding apparatus 12, the latching connection must be released by a movement of the wing portions 54 outwardly. This favourably takes place with the aid of an unlocking tool. The holding portion 18 of the holding apparatus 12 has a contact surface 60 adjoining each of the recesses 58 for such an unlocking tool. This is moved downwardly along the contact surface 60 in order to press the wing portions 54 outwardly and to release the connection between the drill blade element 14 and the holding apparatus 12.

The holding apparatus 12 of the implant drill 50 additionally has a cleaning bore 62 which connects the end of the slot-shaped receptacle 20 that faces in the direction of the actuating portion 16 to the outer periphery 24 of the holding portion 18. Thereby, an effective flushing of the slot-shaped receptacle 20 can be ensured when cleaning the holding apparatus 12.

The holding apparatus 12 of the implant drill 50 according to the third exemplary embodiment is suitable as a component of an implant drill set according to the invention. Such an implant drill set can comprise a plurality of different drill blade elements 14, the connecting portions 28 of which are each configured identically for connecting to the holding apparatus 12, which however have different blade portions 26, in order to be able to produce and/or widen different partial regions of a bore in the jaw bone sequentially, or in order to be able to produce bores for different dental implants.

The implant drill set according to the invention enables a distinct material and cost saving in comparison with implant drill sets which each comprise single-piece implant drills.

### REFERENCE SIGNS

10 Implant drill
12 Holding apparatus
14 Drill blade element
16 Actuating portion
18 Holding portion
20 Slot-shaped receptacle
22 Receptacle surface
24 Cylindrical outer surface
26 Blade portion
28 Connecting portion
30 Bevelled edges
40 Implant drill
42 Portion with smaller width
44 Receptacle
50 Implant drill
52 Central guide portion
54 Lateral wing portions
56 Latching noses
58 Recesses
60 Contact surface
62 Cleaning bore

What is claimed is:

1. An implant drill for producing bores in the jaw bone for dental implants, comprising
a drill blade element which consists of a flat material and is configured substantially mirror-symmetrical relative to a rotation axis of the implant drill, comprising a blade portion with bevelled edges for producing the bore in the jaw bone and a connecting portion, which are arranged in the axial direction at opposite ends of the drill blade element; and
a holding apparatus which is configured substantially rotationally symmetrical relative to the rotation axis, wherein the holding apparatus comprises a holding portion and an actuating portion, which are arranged in the axial direction at opposite ends of the holding apparatus, and wherein the holding portion has a slot-shaped receptacle that is mirror-symmetrical relative to the rotation axis, with two mutually parallel receptacle surfaces,
wherein the connecting portion of the drill blade element is introducible in the axial direction into the receptacle of the holding portion of the holding apparatus, in order to connect the drill blade element non-rotatably to the holding apparatus.

2. The implant drill according to claim 1, wherein the holding portion has a cylindrical outer surface to be received in a drilling sleeve with a corresponding cylindrical inner surface.

3. The implant drill according to claim 1, wherein the holding apparatus is made from high-grade steel.

4. The implant drill according claim 1, wherein the drill blade element is formed integrally from a ceramic material or a metallic material, in particular, from high-strength high-grade steel or surgical steel.

5. The implant drill according to claim 1, wherein the drill blade element is produced by means of eroding, in particular, by means of spark eroding.

6. The implant drill according to claim 1, wherein the drill blade element has a substantially constant thickness, preferably in the range from approximately 0.25 to approximately 0.8 mm, more preferably from approximately 0.5 to approximately 0.7 mm.

7. The implant drill according to claim 1, wherein the receptacle surfaces of the slot-shaped receptacle in the holding portion have a spacing that corresponds to the thickness of the drill blade element in order to receive the connecting portion of the drill blade element substantially play-free.

8. The implant drill according to claim 1, wherein the actuating portion is configured for non-rotatable, releasable connection to a handle.

9. The implant drill according to claim 1, wherein the drill blade element is non-releasably connected to the holding apparatus.

10. The implant drill according to claim 9, wherein the connecting portion of the drill blade element is welded or adhesively bonded to the holding portion of the holding apparatus.

11. The implant drill according to claim 9, wherein the slot-shaped receptacle extends over the whole diameter of the holding portion and the connecting portion of the drill blade element has a width that substantially corresponds to the diameter of the holding portion.

12. The implant drill according to claim 1, wherein the drill blade element is releasably connectable to the holding apparatus.

13. The implant drill according to claim 12, wherein the drill blade element is connectable to the holding apparatus by means of a latching connection or snap-fit connection.

14. The implant drill according to claim 13, wherein the connecting portion of the drill blade element has a central guide portion and two lateral wing portions spaced from the guide portion, wherein the wing portions each have a latching nose oriented toward the rotation axis, wherein the slot-shaped receptacle does not extend over the whole diameter of the holding portion, but rather has a width that substantially corresponds to the width of the central guide portion, and wherein the holding portion has two recesses disposed opposite one another on its outer periphery for receiving the latching noses.

15. The implant drill according to claim 14, wherein, adjoining each of the recesses, the holding portion has a respective contact surface for an unlocking tool, in order to move the lateral wing portions apart and to release the connection between the drill blade element and the holding apparatus.

16. The implant drill according to claim 12, wherein the holding apparatus has a cleaning bore which connects the end of the slot-shaped receptacle orientated in the direction of the actuating portion to the outer periphery of the holding portion.

17. An implant drill set comprising the implant drill according to claim 12 and one or more further drill blade elements, wherein each drill blade element has a connecting portion which is introducible in the axial direction into the receptacle of the holding portion of the holding apparatus, in order to connect the drill blade element non-rotatably to the holding apparatus.

18. The implant drill set according to claim 17, wherein the connecting portions of all the drill blade elements are configured identically, and wherein the blade portions of the drill blade elements are configured identically or differently.

19. The implant drill set according to claim 18, wherein the blade portions of the drill blade elements are configured differently, in order to produce and/or widen different partial regions of a bore in the jaw bone sequentially.
